(19) United States
(12) Patent Application Publication
(10) Pub. No.: US 2026/0221406 A1
(43) Pub. Date: Jul. 30, 2026

(54) ION TRANSPORT DEVICE

(71) Applicant: Ionoscope Limited Liability Company, g. Moskva (RU)

(72) Inventor: Sergey Stanislavovich POTESHIN, g. Moskva (RU)

(21) Appl. No.: 19/041,573

(22) Filed: Jan. 30, 2025

(30) Foreign Application Priority Data
Dec. 28, 2023 (RU) 2023135932

(51) Int. Cl. H01J 49/06

(52) U.S. Cl. CPC H01J 49/065

(57) ABSTRACT

This invention relates to radio frequency devices for transporting, focusing and retaining ions, which are used in mass spectrometry and ion mobility spectrometry applications. An ion transport device comprises an ion transport channel, which has an inlet and an outlet ends, and is bounded by surfaces with arranged radio frequency and/or DC electrodes that generate a traveling-wave field directing ions toward the channel outlet end, wherein the electrodes are arranged in the outlet section of the device to ensure the fragmentation or thermalization of ions, differing from other electrodes arranged in the remaining section of the device by their power supply mode and/or geometry. The technical result consists in achieving high efficiency of ion transport to the next chamber with a different pressure; ensuring high sensitivity of the device during short data accumulation times; reducing gas load on the pumps at subsequent stages; preventing ion packets from blurring during their transport through the device; and preparing ion packets for subsequent manipulations at the subsequent stages of the mass spectrometer, namely, the fragmentation and/or thermalization of ions.

### TECHNICAL FIELD

This invention relates to radio frequency devices for transporting, focusing and retaining ions, which are used in mass spectrometry and ion mobility spectrometry applications.

### PRIOR ART

A mass spectrometer typically consists of an ion source, a vacuum chamber, a mass analyzer, and an ion detector. The ions generated in the ion source are received in the mass analyzer, where they are separated by their mass-to-charge-ratio (hereinafter, the “mass”) and then recorded by the detector. If the ion source is operating at elevated pressure, this requires a system that transports ions into a vacuum chamber with a typical pressure of 1E-5-1E-6 Torr. Such devices are known as differential pumping interfaces, where the pressure drop is divided into multiple chambers/regions. Each subsequent chamber has pressure that differs from the pressure in the adjacent chambers, and is typically separated from the adjacent chambers by apertures that limit a gas flow into the next chamber, wherein to achieve maximum sensitivity the ions must be transported between stages with minimum losses. The apertures with smaller slits between the interface stages exert less load on the pumps; however, a significant part of the ions can be lost when passing through narrow apertures. In complex, multi-component mass spectrometers, the component parts of the instrument or functional units are sometimes referred to as “stages”. These may be interface stages, ion fragmentation cells, ion accumulation devices, ion packet formation devices, or mass analyzers, which may be multiple within a mass spectrometer, etc. For example, a type of ion manipulation in a mass spectrometer involves preparing ions for their subsequent transport to an impulse orthogonal accelerator (OA) and obtaining their time-of-flight (TOF) spectrum. The resolution and transmittance of an orthogonal acceleration TOF mass analyzer significantly depends on the phase volume of the received ion packet. As a result, an important step in preparing an ion packet before introducing it into OA is to reduce its phase volume, which effectively occurs when ions collide with a neutral gas and, consequently, cool down. This process can be also referred to as the thermalization of ions in a gas.

When analyzing the compounds, one of the challenges in mass spectrometry and ion mobility spectrometry is the loss of ions when they pass through differential pumping interface in the process of transporting the ions from a high-pressure region to a high vacuum region, where the ions are separated by mass in the mass analyzer. Ion losses adversely affect the sensitivity of the instrument.

Mass spectrometers, in particular, mass analyzers, are often combined in tandem with devices for the preliminary separation of ions based on some parameter, for example, for high-speed chromatography or with an ion mobility spectrometer (IMS), which separate the sample components at high speeds with a typical time of 200-300 μs (for IMS) and 20-1000 ms (for chromatography). In such a case, along with efficiency, the ion transport systems, that connect these devices to each other, are additionally required to ensure the speed of the focusing and transport system. To avoid losing resolution achieved at the previous stage of separation before the mass analyzer, the ion transport systems should prevent time-separated ion packets received at its input from mixing and blurring. Currently, tandem mass spectrometers have systems that allow focusing and transporting ions in a gas. The most common of them include ion funnel, RF multipoles (quadrupoles, hexopoles, octupoles, etc.) [Douglas D. J., French J. B. Patent U.S. Pat. No. 4,964,746, 1989 r.] and traveling-wave field devices.

An ion funnel is one of the traditional ways to implement a system for transporting and focusing ions, which is an array of electrodes with coaxially arranged holes, wherein each subsequent electrode, in the direction from the outlet of the MS towards the analyzer, has a hole diameter smaller than the previous one, so a space is formed for the movement of ions, i.e. a funnel (U.S. Pat. No. 6,107,628A, Aug. 22, 2000; U.S. Pat. No. 8,299,443B1, Oct. 30, 2012).

The disadvantages of the above devices include low efficiency of ion transport to the next chamber with a different pressure, slow ion transport along the surface, low sensitivity of the device during short data accumulation times, high gas load on the pumps at subsequent stages, blurring of ion packets during their transport through the device, and inability to prepare ion packets for subsequent manipulations at the subsequent stages of the mass spectrometer, namely, the fragmentation and/or thermalization of ions.

The invention described below is aimed at addressing these problems.

### SUMMARY OF INVENTION

The technical task is to create a highly efficient device and ion transport method that ensure high sensitivity of the device during short data accumulation times, prevent the ions from blurring during their transport through the device, and prepare ion packets for subsequent manipulations at the next stages of a mass spectrometer, such as, the ion fragmentation and/or thermalization.

The technical result consists in achieving high efficiency of ion transport to the next chamber with a different pressure; ensuring high sensitivity of the device during short data accumulation times; reducing gas load on the pumps at subsequent stages; preventing ion packets from blurring during their transport through the device; and preparing ion packets for subsequent manipulations at the subsequent stages of the mass spectrometer, namely, the fragmentation and/or thermalization of ions.

The technical result is achieved by the fact that the ion transport device comprises an ion transport channel, which has an inlet and outlet ends, and is bounded by surfaces with arranged radio frequency and/or DC electrodes that generate a traveling-wave field directing ions toward the channel outlet end, wherein the electrodes arranged in the outlet section of the device ensure the fragmentation or thermalization of ions, differing from other electrodes arranged in the remaining section of the device by their power supply mode and/or geometry.

Furthermore, the ion transport channel has a rectangular, round or oval shape in cross-section.

Furthermore, the ion transport channel tapers towards the outlet.

Furthermore, the ion transport channel is formed by two flat opposite surfaces with radio frequency electrodes and two flat opposite surfaces with DC electrodes.

Furthermore, the ion transport channel is formed by four flat surfaces with radio frequency electrodes or electrodes in the form of apertures alternating along the channel.

Furthermore, the electrodes are made in the form of groups of two and/or more electrodes, which are supplied with the appropriate phase-locked RF power.

Furthermore, the electrodes arranged in the outlet section of the device are made as a separate group and arranged along the length of the ion transport channel.

Furthermore, the electrodes arranged in the remaining section of the device are made as a group of electrodes and arranged across the length of the ion transport channel.

Furthermore, the geometry of the electrodes arranged in the outlet section of the device replicates the geometry of the electrodes arranged in the remaining section of the device.

Furthermore, the distance between adjacent electrodes arranged in the outlet section of the device on one surface is less than the distance between opposite surfaces on which the said electrodes are arranged.

Furthermore, the electrodes have a rectangular shape or have the shape of a circular sector with the center of the circle located on the axis of the surface or have another curved shape.

Furthermore, the diameter or size of the curvature in the electrodes varies towards the outlet of the device.

Furthermore, the electrodes have a repeating pattern along the length of the surface.

Furthermore, the electrodes have a pattern and scale that vary along the length of the surface.

Furthermore, the surfaces bounding the channel contain holes or pores.

Furthermore, the surfaces bounding the ion transport channel and field electrodes are manufactured using printed circuit board technology.

Furthermore, the channel formed by the surfaces with electrodes is hermetically sealed or has limited gas permeability and can resist a gas flow through the channel.

Furthermore, the ion transport device can retain and accumulate ions in the outlet section of the channel.

Furthermore, the ion transport device can transport ions through itself to a region with a higher pressure than at the device inlet.

### BRIEF DESCRIPTION OF THE DRAWINGS

FIG. 1. A preferred embodiment of the invention for viscous and molecular-viscous flow with controlled fragmentation cell;

FIG. 2. A preferred embodiment of the invention for molecular flow with ion thermalization cell;

FIG. 3. SIMION-simulated dependence of the effective temperature (Teff) of ions on their position along the channel length;

FIG. 4. Distribution of pressure along the channel length when two chambers with pressures P1=10 Torr and P2=0.01 Torr are connected by such channel;

FIG. 5. Electrode system in the preferred embodiment of ion transport device for a molecular flow of gas through the channel;

FIG. 6. An embodiment of the ion transport device with narrow channels within a differential pumping interface.

### EMBODIMENT OF THE INVENTION

The disclosed invention is aimed at devices and methods for transporting, focusing and trapping ions in gases in a wide range of pressures with minimum loss of ions using electric fields.

The main scope of the disclosed device (hereinafter, the “ion transport device”) is the differential pumping interfaces, and inlet or outlet stages of devices for separation of ions by their properties, e.g., by their mobility or m/z ratio.

The disclosed ion transport device is aimed at performing a set of tasks in order to improve the characteristics of the mass spectrometer. Namely, this includes transporting the ions more efficiently, with minimum losses, from a region with a certain pressure to a region with another pressure; reducing gas load on the pumps at subsequent stages; preventing blurring of ion packets during the transport over time; and, depending on the analysis task, the device should perform the fragmentation and/or thermalization of ions.

For ion sources operating at high pressure, it is necessary to use differential pumping interfaces that transport ions from the high-pressure region to the high vacuum region, in which their m/z separation occurs. Typically, gas flow is limited using apertures with small slits, but the use of narrow apertures leads to ion losses and, as a consequence, to a decrease in sensitivity. On the other hand, the use of apertures with a larger slit leads to an increase in the gas load on the vacuum pumps used to pump out the stage after the aperture. The invention provides a reduction of the gas load by increasing the length of the channel connecting two chambers with different pressures. To prevent the loss of ions while they move in a long channel, it is necessary to ensure their transport without substantial losses by using radio-frequency focusing fields.

One of the solutions to achieve the technical result is to increase the length of the channel, through which the ions are transported to the next stage, by five or more times, i.e. to make the channel significantly larger than its characteristic dimension in cross-section. First, a longer channel allows to substantially increase the inlet aperture of the ion transport device. Secondly, this solution limits a gas flow into the next stage. In the preferred embodiments, a rectangular cross-section of the channel was selected for three reasons: 1) With viscous and molecular-viscous flow, the conductivity of the channel in this case is significantly smaller (see the expression for conductivity below); 2) The volume charge has a reduced impact compared to a circular channel of similar cross-section; 3) The flat surfaces are convenient for arranging an electrode system, which generates a transport and focusing field.

The conductivity of a rectangular channel with molecular-viscous flow, if Kn~0.005 . . . 5, as in our case, can be estimated by the following formula:

$$Uab\_mv := 865 \cdot f \cdot a \cdot {b}^{3} \cdot \frac{P m i d}{L}$$

where, ‘f≈4.5’ is a parameter that depends on the aspect ratio of the rectangle in the cross section, ‘a’ is the size of the long side, ‘b’ is the size of the short side, ‘Pmid’ is the mean pressure in the channel, ‘L’ is the length of the channel.

The conductivity of the aperture can be estimated by the following formula:

U_{hol_v}=160·d_hol², where ‘d_hol’ is the diameter of the aperture.

If the parameters of the channel in the preferred embodiment have a cross-section of 1×6 mm and a length of L=100 mm, then approximately the same conductivity will be provided by the aperture with a slit of d_hol=1 mm, i. e. with an area that is 7.6 times smaller. Or if the aperture has a slit of a similar area equal to 6 mm², the flow through it will be approximately 10 times higher.

For the molecular flow, the conductivity of a rectangular channel with the length of L can be estimated by the following formula:

$$Uab\_mol = \frac{308 \cdot φ \cdot {a}^{2} \cdot {b}^{2}}{L \cdot ( a + b )} ,$$

where ‘a’ and ‘b’ are the side lengths of a rectangular section. The conductivity of a round aperture for molecular flow can be estimated by the following formula:

U_{hol_mol}=91·d², where ‘d’ is the diameter of the aperture.

For parameters of the channel in the preferred embodiment with molecular flow, the length ‘L’ is 100 mm, and the cross-section is 1×2.5 mm. If the aperture has a slit of a similar area equal to 2.5 mm², the flow through it will be approximately 10 times higher.

A solution that allows achieving the technical result provides for using traveling-wave field to transport ions along the channel. This will avoid mixing time-separated ion packets from different components of the sample. Their separation can be achieved at preceding separation stages such as gas chromatography (GC), liquid chromatography (LC), or ion mobility spectrometry (IMS). The claimed ion transport device should ensure characteristic times for blurring time fronts of concentration changes in mixture components at the level of 50-200 μs and below.

FIG. 1 presents an embodiment of ion transport device to transport and manipulate ions for molecular-viscous flow, with such embodiment comprising a region or chamber (1) with pressure P1, inlet slit (2), through which the ions arrive from the chamber (1) to the ion transport channel (10), formed by preferably flat surfaces with a plurality of RF field-setting electrodes (5) N (7) and two preferably flat surfaces containing DC electrodes (6). The action of the fields generated by the plurality of electrodes (5 and 7) and the electrode (6) results in the formation of an ion transfer channel (10), in which the ions are retained and move along Z axis towards the outlet of the ion transport device. In a preferred embodiment, the ions move towards X axis by the force of electric traveling-wave field, which directs the ions along the ion transfer channel (10) from the inlet slit (2) to the outlet slit (8) and further to the region or chamber (9) with pressure P2. This field is set by the groups of electrodes (5 and 7).

In the direction of Y axis, the ion transfer channel (10) is bounded by the surface comprising the electrode (6), which is supplied with DC voltage so that the field generated by the electrode (6) directs ions into the channel (10) and prevents the loss of ions in the direction of Y axis. Applying+0.3 . . . +2V or more volts relative to the channel potential on the axis for positively charged ions will be sufficient to prevent the loss of such ions. As an option, the flow of ions from the channel in the direction of Y axis can be limited by placing DC electrodes on the surfaces where the electrodes (5 and 7) are arranged.

As an option, the flow of ions from the channel in the direction of Y axis can be limited by arranging the same groups of electrodes as (5 and 7) instead of electrodes (6) and using them to generate a similar traveling-wave field as on the surfaces, where the electrodes (5 and 7) are arranged.

The surfaces bounding the channel (10) form a hermetically sealed channel or the channel has limited gas permeability and is made to resist gas flow through the channel.

As an option, the surfaces bounding the channel (10) may contain a plurality of holes or pores to ensure additional outflow of gas from the channel and ensure that the pressure drop along the length of the channel is faster or varies according to a certain pattern.

An aperture (8) with a slit, at which the ions are focused in the outlet from the channel, may be arranged in the outlet from the channel (10). The slit of such aperture may have a smaller area than the channel and, in that case, the aperture may further limita gas flow through the channel.

The traveling-wave field is the preferred type of field for transporting ions in narrow channels to address the technical task. Its use allows to substantially reduce the blurring of ion packets transported through long and narrow channels. Blurring of ion packets is caused primarily by the fact that, in narrow channels, the gas moves with different velocity. If there is no electric field to move the ions along the axis, the speed of this motion will be largely determined by the gas velocity at the ion position. In the viscous mode, when the gas moves through the channel in laminar flow, this sets the Poiseuille flow mode, while the cross-sectional distribution of the flow velocity will be close to parabolic. The maximum velocity will be on the axis, while on the surface that limits the channel, the flow velocity will be close to 0 according to the following expression:

$$v ( r ) = \frac{{p}_{1} - {p}_{2}}{4 η L} ( {R}^{2} - {r}^{2} ) .$$

As a result, different ions will eventually arrive at the channel outlet at different times. Simulated ion motion through a channel with a length of L=100 mm and a cross section of 1 mm, when P1=10 Torr, P2=0.01 Torr and assuming that the gas flows in Poiseuille flow mode for 200 m/z ions, shows that the fronts are blurred by 200-400 μs at 50% of the peak height. If in the previous stage, the ion packets were separated in time, depending on their properties, such as m/z, collision cross section or their combination, and the characteristic peak duration time was 100-300 μs, such blurring would significantly degrade the ion separation in time achieved in the previous stage. The traveling-wave field solves this problem in a radical way. Simulated ion motion under the same conditions of gas flow through the channel, with the preferred power supply mode and preferred RF electrode structure (described below), shows that blurring of ion packets is only 30-40 μs.

Next, in a preferred embodiment, for viscous and molecular-viscous flow, the electrode system of the channel (10) is divided into at least two regions (3) and (4), that have different power supply modes. The structure of the electrodes may also differ in these regions. However, in order to simplify the manufacturing and achieve the technical result, it is sufficient to implement different power supply modes, wherein the geometry of electrodes (4) may replicate the one of electrodes (3). This is done to ensure that the ion fragmentation process is controllable as ions move through the channel, and to further streamline the ion transport mode in view of reducing blurring of ion packets in time. It is known that, during the flow through long narrow channels, the pressure is distributed in such a way that the main pressure drop occurs in the outlet section of the channel at a short distance, which is about 1/10 of the channel length. This is shown in the graph (see FIG. 4) generated by simulating the outflow of gas through a 1×6 mm channel with a length of 100 mm from a chamber with a pressure of P1=10 Torr to the chamber with a pressure of P2=0.01 Torr. As the pressure in the outlet section is very different from the average pressure in the channel (by more than an order of magnitude), the electrodes should preferably be supplied with power in a different mode. It is known that, at greater pressures, higher amplitudes of RF voltages supplying power to electrodes are required to retain and transport the ions. Therefore, the optimal parameters of fast transport along the channel using traveling-wave field are different for different pressures in the channel. When the ions move in a gas under the field effect, the energy of collisions between the ions and the gas is higher than the temperature of the ambient neutral gas. This creates the so-called “field-induced ion heating” with a characteristic effective temperature (Teff) of ions, wherein the energy of collisions between the ions and the gas can be converted into the internal energy of the ionized molecule, which can cause its fragmentation.

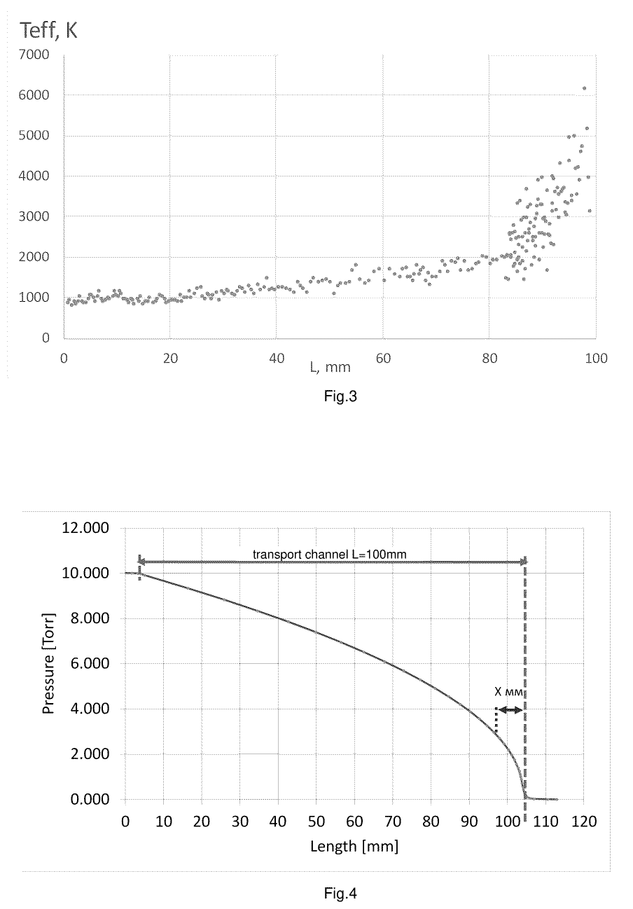

For an ion transport device, two modes of operation need to be considered: operation in transport mode and operation in fragmentation mode. As shown on FIG. 3, the effective temperature (Teff) of ions substantially changes in the outlet section of the channel. The characteristic temperature, at which some types of brittle molecules begin to fragment, is ~1000° . . . 1500° K. To prevent undesired fragmentation, it is necessary to change the RF power supply mode for the electrodes of group (4) shown on FIG. 1 in the outlet section of the channel, namely, to reduce the amplitude by 1.2-5 times, depending on the type of transported ions. Conversely, if the device should operate in fragmentation mode, the amplitude of RF power supply mode for the electrodes of group (4) shown on FIG. 1 should be increased by 1.2-5 or more times.

Therefore, if the ion transport device operates in fragmentation mode, an ultrafast fragmentation of time-separated ion packets can be achieved without blurring them in time or mixing them at characteristic times of 30-200 μs for different types of ions.

The preferred options of the power supply modes for the geometry of electrodes described below are as follows: amplitude of 2-60 V or more, frequency of 1-4 MHz or more, and signal shifted by 90° for adjacent electrodes to provide traveling-wave field. A particular amplitude value has an optimum for a selected mass. For light masses, e.g., 30-100 m/z, the optimal amplitudes are 5-10V, for heavy masses, e.g., 1000 m/z, the amplitudes are 30-60V. As an option of power supply, the adjacent electrodes are supplied with RF voltage in counter-phase with the amplitude of 5-50 V and frequency of 1-4 MHz, and such voltage is separately superimposed with a slowly changing voltage at the frequencies of 0.01-0.5 MHz and amplitude of 0.03-20V. The parameters of RF power supply for the electrodes are not limited to the specified limits and can be within a wider range. As noted above, the parameters of RF power supply for the electrodes of group (4) can be configured separately depending on the selected mode of operation.

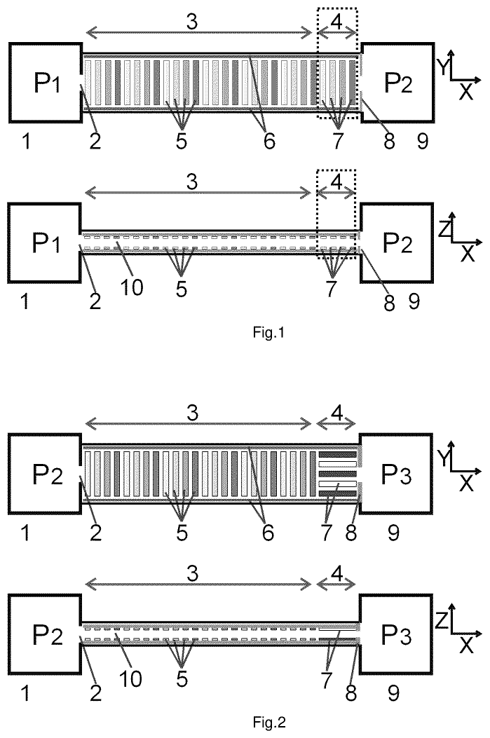

FIG. 2 shows an embodiment of the ion transport device to transport and manipulate ions for the operation in the molecular flow of gas. The device operates on the same principle and comprises the same components. It differs by its preferred power supply mode for the group of electrodes (5 and 7), and by the fact that group of electrodes (4) performs another function and differs from group (3) not only by its power supply mode, but also by its geometric parameters.

The main function of the electrode group (4) is the additional thermalization of ions before they are released into the next stage. The smaller the energy spread in the beam of ions arriving at the ToF mass analyzer, the higher will be m/z resolution of the beam and the lower will be the ion signal loss. An effective way to reduce the energy dispersion in an ion packet is to cool down such packet in a neutral gas, wherein the ions are retained in the transport channel (10) by means of RF fields in order to avoid the loss of ions.

The simulation of the ion transport only by traveling-wave field at characteristic pressures of 10⁻⁴ . . . 0.1 Torr showed that there is an increased energy spread at the outlet of such devices due to particular features of the traveling-wave field. Such energy spread has a characteristic value that is proportional to the amplitude of the power supply providing that field. The efficient transport of ions through the channel, which also prevents ion packets from being blurred in time, is achieved by a power supply amplitude of 0.5-3V for the traveling-wave field and, accordingly, the ions will have an energy spread close to these values, which is unacceptable for achieving high mass resolution in ToF mass analyzers. Multipole fields (such as quadrupole, hexopole, octupole fields, etc.) achieve more efficient cooling because, unlike in the case of traveling-wave fields, the field potential on the axis, where the ions are focused, does not fluctuate. Therefore, the group of electrodes (4) generates a group of quadrupoles located along the X axis of the device. The group of electrodes (4) can be formed on the surface by electrodes in the form of strips aligned along the X axis. Therefore, two or more groups of electrodes are formed along the Y axis, generating an approximate quadrupole field. The width of strips can vary from 0.05 mm to 1 mm or more, depending on the width of the channel in the direction of the Y axis. In other embodiments, the electrodes (7) are not necessarily required to provide exactly a quadrupole field, with a characteristic arrangement of electrodes at approximately the same distance from the quadrupole axis and with a characteristic counter-phase power supply at adjacent electrodes. To retain ions in the channel, the electrodes on the surface must, first of all, generate a sufficient pseudopotential. Therefore, the characteristic distance between adjacent strips (7) on one surface may be smaller than the characteristic distance between opposite surfaces on which the electrodes are held (7).

In the device, two main modes of operation can be identified for the electrodes of group (4): the accumulation mode and the ion transport mode. In the accumulation mode, with the power supply, a locking potential, that prevents ions from leaving the channel (10), is applied to the aperture (8), as shown on FIG. 2. For the ion transport mode, a voltage, that pulls ions from the channel (10) and directs ions to the outlet from the aperture (8), is applied to the electrode (8). The length of the electrodes (4) and the pulling potential on the aperture (8) are selected so that the time of pulling the ion packet in the transport mode from the region of the electrodes (4) does not exceed 10-100 μs, when the device is operated in the high time resolution mode.

A similar effect from changing the ion accumulation mode and ion transport mode can be achieved by changing the average potential, on which the RF component is superimposed, for the electrode system (4) relative to the average potentials of adjacent electrodes (3) and the outlet aperture.

For other modes that do not require such fast dynamics, the ion outflow time can be substantially increased by reducing the pulling potential at the aperture (8). The energy spread in the beam of pulled ions will decrease, and this allows to optimize the ion beam parameters at the outlet to achieve a higher resolution of the mass analyzer. The alternation of the above modes allows to form ion packets of the required duration.

In some embodiments of the device, when the ion energy spread at the outlet of the ion transport device is not critical, for example, when ions are transported to the quadrupole for their further filtration by m/z, there may be no group of electrodes (4), which performs the function of ion thermalization.

In the preferred embodiments, the individual electrodes of the plurality of RF electrodes (5 and 7, FIG. 1, 2) are rectangular and are separated by an insulator, and have a periodically repeating pattern consisting of groups of 2, 3, 4, 5 or more electrodes. The most preferred embodiment for groups (5) and (7) in FIG. 1 and for (5) in FIG. 2 is when the array comprising a plurality of RF electrodes is divided by groups of 4 electrodes to set the traveling-wave field.

The channel formed by the surfaces with RF electrodes (5 and 7 in FIG. 1) may be tapering towards the outlet in order to further limit the reduction of the overall conductivity in the channel for the gas flow to the next stage.

According to a preferred embodiment, the repeating pattern of the field setting electrodes (5 and 7) extends over most of the surface.

The size of the electrodes and the distance between them may vary based on the electric field requirements for different ion transport conditions. In typical examples when the ion transport device is operated at pressures ranging from 0.00001 to 100 Torr, the gap between the electrodes ranges from 0.05 mm to 1 mm, including more than 1 mm, the width of an individual electrode may range from 0.05 mm to 1 mm, including more than 1 mm.

In one embodiment, the shape of the individual electrodes (5 and 7), in addition to being rectangular, may have the shape of a circular sector with the center of the circle on the axis of the surface, an angular shape, or another curved shape. The diameter or characteristic size of the curvature of the electrodes may vary towards the outlet of the device. In this case, the traveling-wave field will additionally guide ions from the peripheral region to the central axis of the device.

In one embodiment, the scale of the repeating pattern may vary along the length of the surfaces that form the channel. For example, at the inlet of the ion focusing device, the scale of the pattern can be approximately 1.2-5 or more times larger than the scale of the pattern at the outlet of the ion focusing device.

The most preferred embodiment for the group (7) shown in FIG. 2 is when the array of the plurality of RF electrodes is divided into groups of 2 electrodes each, wherein a counter-phase voltage is applied respectively to set a field that retains ions in the channel and to ensure that the potential on the field axis does not fluctuate in time.

In one embodiment, the surfaces bounding the ion transport channel and field electrodes are manufactured using printed circuit board technology.

The ion transport device may be preceded by an additional ion focusing system that focuses and directs ions into the ion transport device channel, such as an IonFunnel or other similar device with a similar function.

The power supply of the electrodes may vary in accordance with the requirements to the electric field for different ion transport conditions. In a preferred embodiment, the electrodes (5) and (7) shown in FIGS. 1 and (5) shown in FIG. 2 are supplied with power in such a way that a traveling-wave field is generated above the electrode surface when a field is created with alternating maxima and minima of potential that move along the surface above the electrodes. To generate an electric traveling-wave field, a time-varying voltage with a phase shift relative to the adjacent group of electrodes is applied to alternating groups of electrodes. In each group, starting from the first and up to the last electrode along the course of ion motion, the voltage phase at adjacent electrodes is shifted so as to form “peaks” and “troughs” of potential that move along the surface. In a conventional case, the selected value of phase shift is 360/n, where ‘n’ is the number of electrodes in the group. Thus, in one group, the first electrode retains the first voltage value, the second electrode retains the second voltage value, etc. At the first time ‘t1’, the first voltage is applied to the first electrodes of all groups, the second voltage is applied to the second electrodes of all groups, etc., respectively. At the second time ‘t2’, the first voltage is applied to the second electrodes in each group, the second voltage is applied to the third electrodes in each group, etc. As a result, the pushing field over the electrodes “makes steps”, creating a traveling-wave field that causes the ions to move in the selected direction.

Two types of ion motion are possible depending on the ratio of the ion velocity to the traveling-wave velocity. If the ions have very high mobility, they move along with the wave. In this case, the ion velocity turns out to be equal to the traveling-wave velocity. If the ion is carried away by the potential wave and “slides” along the “crests”, this results in the ion velocity lower than the wave velocity. In such case, the ions will move in the wave field with different velocities along the channel depending on their mobilities. Ions with higher mobility will move along with the wave a significant part of the time, while ions with lower mobility will “skip” the wave crests more often. The more the ions “skip” the peaks, the slower they move through the device.

The amplitude and frequency of RF voltages applied to the electrodes (5 and 7) depend on the characteristic size of the electrodes, the amount of pressure in the channel, the type of neutral gas, the step between the electrodes, and the aggregate of m/z and CCS of ions passing through the channel. For the selected size of electrodes, the amplitude is 10 . . . 50 V, with a characteristic frequency of 0.5-5 MHz for ions with m/z=200 V, but it is not limited to this range.

In one embodiment, the voltages applied to the groups of electrodes may represent the sum of voltages that change at different frequencies and with different sets of phases and amplitudes. In a preferred embodiment, the power is supplied as follows. A counter-phase signal with a higher frequency, e. g. 0.2 . . . 10 MHz or more, is applied to the adjacent electrodes. This RF voltage generates a field that retains the ions in the channel. Another signal is superimposed on that signal with a different frequency, which is preferably 1.2 . . . 20 or more times lower than the first one, and with a phase shift relative to adjacent electrodes in the group, wherein such frequency is distributed over the said groups of electrodes. The signal is applied to the adjacent electrodes with a phase shift that corresponds to the selected number of electrodes in the group. For example, if there are 4 electrodes in a group, the phase shift will be 90°. The preferred amplitude of the second signal should be 1.2 . . . 20 or more times smaller than the amplitude of the first signal.

In the most preferred embodiment for RF voltages applied to the group (7) shown in FIG. 2, a counter-phase signal is applied to the adjacent electrodes to set the field that retains ions in the channel. The amplitude is 5 . . . 100 V, with a characteristic frequency of 1-5 MHz for ions with m/z=200 V, but it is not limited to this range and may vary widely depending on the characteristic size of the electrodes, the amount of pressure in the channel, the type of neutral gas, the step between the electrodes, and the aggregate of m/z and CCS of ions passing through the channel.

Also, other embodiments are possible, wherein the same or similar potentials are applied to 2 . . . 4 adjacent electrodes in a group of electrodes to set the traveling-wave field. This is aimed at ensuring a more uniform field gradient at the traveling-wave field fronts and, thereby, reducing the blurring of the time fronts in moving ion packets.

The supply voltage may be a sinusoidal signal, have a rectangular or triangular, sawtooth shape, or other signal forms. The term “RF electrodes” does not limit the power supply mode of the electrodes to RF voltage only.

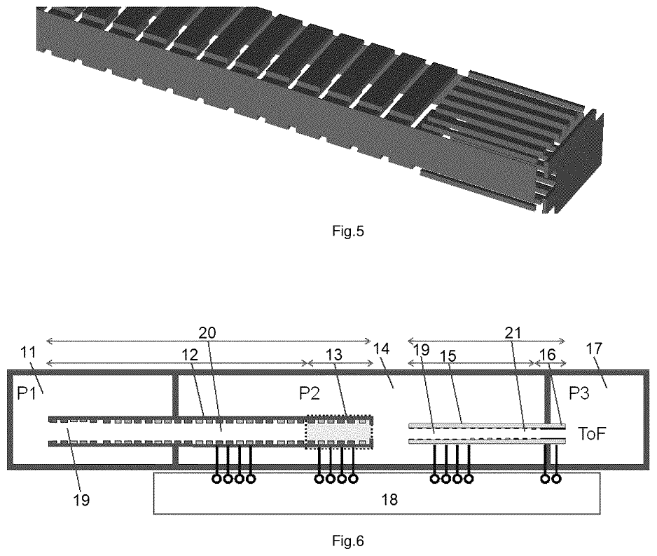

FIG. 6 shows an embodiment of the ion transport device with narrow channels within a differential pumping interface (14). The figure shows two types of the preferred embodiment of the ion transport device depending on the mode of gas flow through the channel: when the gas flows in the molecular-viscous mode (20), the device has an ion fragmentation cell (13); in case of molecular flow (21), the device has a cell for thermalization and ion accumulation (16) to prepare the ion beam for injection into the TOF mass spectrometer. The ion accumulation mode can be applied to reduce the duty cycle effect in the subsequent ToF mass analyzer and improve the ion packet thermalization. Ions arrive to the channel (19) of the ion transport device (20) from a chamber (11) with a pressure P1 that may be 0.5 . . . 20 Torr or more; and through the electrodes (12) connected to the means for applying power supply voltages (18), the ions are transported to the outlet of the ion transport device (20), where they can be fragmented into sections (13). Next, ions or their fragments arrive to a chamber (14) with a pressure of P2~0.001-0.1 Torr and then to the ion transport device (21), and the ions are transported to the traveling-wave field, which is set by the electrodes (15) connected to the means for applying power supply voltages (18), and arrive to a region (16) that provides the ion thermalization function. After thermalization, the transported ions arrive in a chamber (17) with a pressure of P3~10⁻⁵ . . . 10⁻⁹ Torr, where a mass analyzer or a chamber with intermediate pressure preceding the mass analyzer is located.

While being transported through the ion transport device (20 and 21), ions experience minimum losses and minimum blurring of ion packets over time, and the channels (19) limit the gas flow to the next stage.

In some embodiments, the ion transport device (20 and 21) may be preceded by additional ion focusing devices such as ion funnels, ion focusing lenses, etc.

Preferably, the described differential pumping interface operates in conjunction with an ion mobility spectrometer (IMS) that separates ion packets based on the aggregate of their properties, such as m/z and CCS. This may be a drift IMS (20) in a chamber (19) with ion separation by a traveling-wave field.

Preferably, the described interface is used in conjunction with high-resolution ToF mass analyzers that require high vacuum. However, the disclosed devices can also be used with other types of mass analyzers, such as quadrupole mass analyzers, Orbitrap, ICR, magnetic mass analyzers, etc.

Also, in other potential embodiments, the described ion transport devices may transport ions to the higher pressure region from the lower pressure region when P1<P2 or P2<P3.

Constructing the claimed device in a way described above improves the efficiency of ion transport to the chamber with a significantly differing pressure; ensures high sensitivity of the device, particularly during short data accumulation times; reduces gas load on the pumps at subsequent stages; prevents ion packets from blurring during their transport through the device; and prepares ion packets for subsequent manipulations at the further stages of the mass spectrometer, namely, fragmentation and/or thermalization of ions.

1. An ion transport device characterized in that it comprises an ion transport channel, which has an inlet and an outlet ends, and is bounded by surfaces with arranged radio frequency and/or DC electrodes that generate a traveling-wave field directing ions toward the channel outlet end, wherein the electrodes are arranged in the outlet section of the device to ensure the fragmentation function or thermalization of ions, differing from other electrodes arranged in the remaining section of the device by their power supply mode and/or geometry.

2. The ion transport device of claim 1 characterized in that the ion transport channel has a rectangular, round or oval shape in cross-section.

3. The ion transport device of claim 1 characterized in that the ion transport channel tapers towards the outlet.

4. The ion transport device of claim 1 characterized in that the ion transport channel is formed by two flat opposite surfaces with radio frequency electrodes and two flat opposite surfaces with DC electrodes.

5. The ion transport device of claim 1 characterized in that the ion transport channel is formed by four flat surfaces with radio frequency electrodes or electrodes in the form of apertures alternating along the channel.

6. The ion transport device of claim 1 characterized in that the electrodes are made in the form of groups of two and/or more electrodes to which with the appropriate phase-locked RF power is supplied.

7. The ion transport device of claim 1 characterized in that the electrodes arranged in the outlet section of the device are made as a separate group and arranged along the length of the ion transport channel.

8. The ion transport device of claim 1 characterized in that the electrodes in the remaining section of the device are made as a group of electrodes and arranged across the length of the ion transport channel.

9. The ion transport device of claim 1 characterized in that the geometry of the electrodes arranged in the outlet section of the device replicates the geometry of the electrodes arranged in the remaining section of the device.

10. The ion transport device of claim 1 characterized in that the electrodes have a rectangular shape or have the shape of a circular sector with the center of the circle located on the axis of the surface or have another curved shape.

11. The ion transport device of claim 1 characterized in that the electrodes have a repeating pattern along the length of the surface.

12. The ion transport device of claim 1 characterized in that the electrodes have a pattern and scale that vary along the length of the surface.

13. The ion transport device of claim 1 characterized in that the surfaces bounding the channel contain holes or pores.

14. The ion transport device of claim 1 characterized in that the surfaces bounding the ion transport channel and field electrodes are manufactured using printed circuit board technology.

15. The ion transport device of claim 1 characterized in that the channel formed by the surfaces with electrodes is hermetically sealed or has limited gas permeability and can resist a gas flow through the channel.

16. The ion transport device of claim 1 characterized in that the ion transport device can retain and accumulate ions in the outlet section of the channel.

17. The ion transport device of claim 1 characterized in that the ion transport device can transport ions through itself to a region with a higher pressure than at the device inlet.
